(19) United States
(12) Patent Application Publication
(10) Pub. No.: US 2009/0293703 A1
(43) Pub. Date: Dec. 3, 2009

(54) LUG PROTECTOR FOR A TENSION SYSTEM ON A DRUM

(76) Inventor: Jan Roelof van der Meulen, Brunssum (NL)

Correspondence Address: BERENATO, WHITE & STAVISH, LLC, 6550 ROCK SPRING DRIVE, SUITE 240, BETHESDA, MD, 20817, US

(21) Appl. No.: 12/211,291

(22) Filed: Sep. 16, 2008

Related U.S. Application Data
(60) Provisional application No. 61/057,976, filed on Jun. 2, 2008.

(51) Int. Cl. G10D 13/02

(52) U.S. Cl. 84/413

(57) ABSTRACT

A protector device for the tension lock of a conga or the like provides a cost-effective production and easy attachment and the possibility of operation of the tension nut in the attached condition. The protector device comprises a main body, which is U-shaped in its horizontal cross section and radially open on the inside toward the conga, accepting the tension lug of the conga. A slot in the top portion snaps onto the tension hook in the attached position and the tension nut is exposed so that a tightening of the tension lock via the tension nut is possible even when the protector device is attached, without having to remove the protector device.

This application is a U.S. Utility Patent Application based on U.S. Provisional Patent Application No. 61/057,976 filed Jun. 2, 2008 and is hereby incorporated by reference in its entirety.

### BACKGROUND OF THE INVENTION

1. Field of the Invention

The present invention relates to a protector device for the tension lock on a conga or the like, i.e., for percussion instruments having a skin that can be tensioned and tuned by means of rods using a multiplicity of tension locks spaced around the instrument's periphery.

2. Background Art

In general, drums such as bass drums, snare drums, and marching drums are equipped with a drumhead stretching mechanism for supporting and stretching drumheads to apply a prescribed tension. In short, these percussion instruments have a skin that can be tensioned and tuned by means of rods using multiple tension locks spaced around the instrument's periphery.

These tension locks are known in different percussion instruments to cause damage; in congas in particular due to the convexity of the resonant body, to cause damage when two congas collide during transportation or while they are being played. It will be understood that the playing of musical drums, such as conga drums and the like, involves a degree of frenetic movements whereby the instruments frequently strike one another. It will also be understood that the tuning mechanisms involved with such drums are commonly made from steel including a threaded rod and nut which are adjusted to vary the tension on the drum head and which project from the external surface of the drum. Since the shells of these drums are typically made of wood, fiberglass or composite materials with the exteriors usually finished in a fine wood finish, gel coat, or other decorative finish, they are susceptible to damage when they contact one another.

It is already known to provide protector devices for the tension locks in order to prevent adjacently situated instruments from being scratched; the known protector devices have the shortcoming, however, because they are not easy to attach and the instruments cannot be tuned with the protector devices attached.

### SUMMARY OF THE INVENTION

The invention provides a protector device that can be created cost-effectively and easily attached and that an operation of the tension nut is possible in the attached condition when the protector is in the attached position.

According to the invention, a main body is U-shaped in its horizontal cross section, radially open on the inside toward the conga and accepting the tension lug of the conga. A recess or cutout in the cover into which the slot opens and which, in the attached position, envelopes the tension lug to envelope a portion of the tension lug system.

A protector device according to the invention can, accordingly, be snapped onto the tension lock in a radially inward direction, widening the slots in the process, and then reliably protects a tension lock with a protector device from scratching an adjacently situated instrument. Furthermore, injuries during carrying and playing are also prevented. Since the bottom of the protector device encloses only the upper side of the tuning rod, re-tightening and tuning is possible without problem even with the protector device attached.

The protector device is advantageously molded in one piece from plastic and can thus be manufactured cost-effectively.

The invention will be described in greater detail below based on a preferred embodiment in combination with the drawing.

### BRIEF DESCRIPTION OF THE DRAWING

FIG. 1 shows a vertical section through the tension lock region of a conga;

FIG. 2 shows a upside-down view of an inventive protector device;

FIG. 3 shows a bottom view of the protector device shown in FIGS. 1 and 2.

### DESCRIPTION OF THE PREFERRED EMBODIMENT

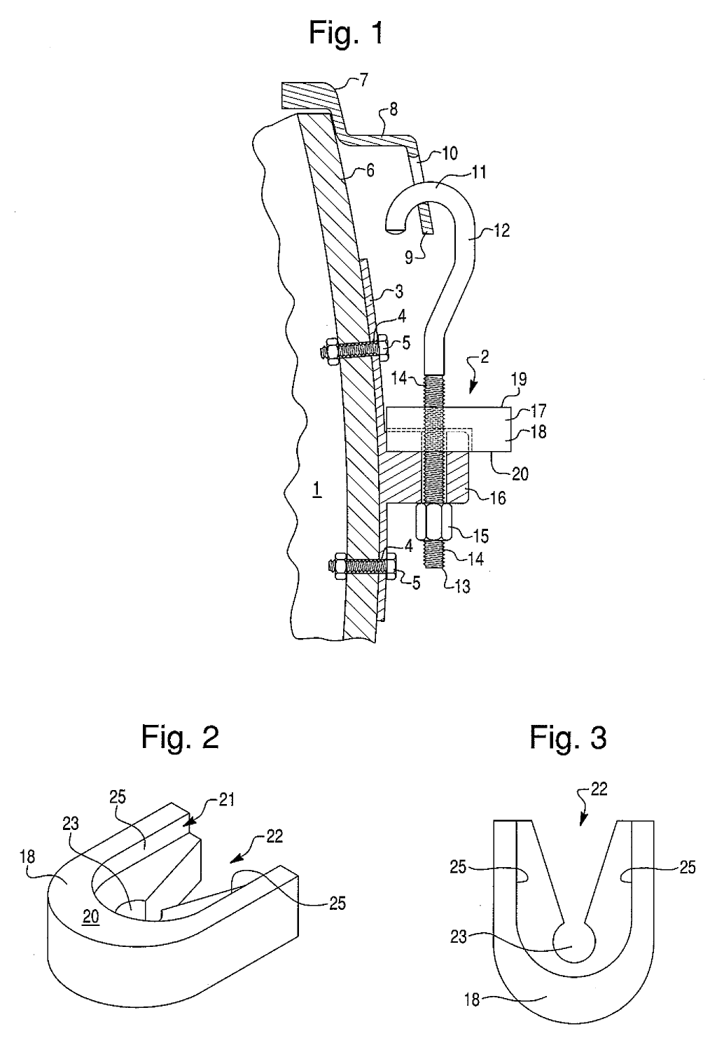

In FIG. 1 a partial section of a conga 1 is depicted in the region of the tension lock 2. The tension lock comprises a base plate 3 with bores 4 through which fastening bolts 5 are bolted through the wooden wall 6 of the conga 1.

At the top of the conga 1, a tension loop 7 is affixed for the skin, which is not shown in the drawing, to which hooks 8 are fastened that have projections 9 that are crimped in an L-shape and have cutouts 10 into which the first end 11 of a tension hook 12 engages. The structure of the tension hook 12 is known in the art. The second end 13 opposite the first end 11 of the tension hook 12 is provided with an exterior thread 14 onto which a tension nut 15 is screwed.

The tension hook 12 extends, with the region of its thread 14, through a tension lug 16 that is connected to the base plate 3 of the tension lock 2.

Tightening the tension nut 15 causes the tension hook 12 to be pulled downward so that tension is exerted onto the tension loop 8 and the same is tightened more firmly. By moving the tension nut 15 in the other direction, i.e., by loosening the tension nut 15, the tension onto the tension loop 7, and thus onto the skin, is reduced.

This tension lock 2, especially its tension lug 16, protrudes outward, as is apparent from FIG. 1, beyond the wall 6 of the conga 1. This creates the danger of damage to other musical instruments during transportation or playing, particularly for other congas.

To prevent damage to the conga 1, a protector device 17 made of plastic is provided, which is shown in FIGS. 1, 2 and 3. It comprises a main body 18, which is approximately U-shaped in its horizontal cross-section (see FIG. 3) and has a top 19 and a bottom 20 (see FIG. 1).

The protector device 17 has a recessed area 21 and vertical tapered v-shaped slot 22 with the vertical tapered v-shaped slot 22 opening into an approximately circular cutout 23 or aperture that is larger relative to the narrow portion of the v-shaped slot 22. The v-shaped slot 22 and aperture 23 define a keyhole opening as shown in FIG. 3. The recessed area is sized to fit over the lug 16 and defined by u-shaped wall 25.

The v-shaped slot 22 and circular cutout or aperture 23 are dimensioned such that the protector device 17 can be pushed radially inward from outside, while elastically widening the slot 22, into the position shown in FIG. 1, on the tension lock 2 over the tension lug 16, so that the top 19 covers the tension lug 16 from the top. The tension nut 15 is exposed so that a tightening of the tension hook 12 via the tension nut 15 is possible even when the protector device 17 is attached, without having to remove the protector device 17.

While the foregoing invention has been shown and described with reference to a preferred embodiment, it will be understood by those of skill in the art that various changes in form and detail may be made therein without departing from the spirit and scope of the presently claimed invention.

1. A drum protector device disposed on tension systems to prevent adjacently situated instruments from being damaged, comprising:
a main body;
an aperture passing through a top wall in said main body;
a v-shaped cutout in said top wall, said v-shaped cutout mating with said aperture to define a key-hole shaped opening toward a side of said main body.
wherein said key-hole opening faces said drum and is adapted to snap onto the tension lug of the drum.

2. The drum protector according to claim 1, wherein said main body includes a cutout defining an internal wall that partly circumscribes said tension lug, whereby said top wall and said internal wall partly envelope said tension lug while leaving a tension lug completely exposed.

3. The drum protector according to claim 1, wherein said main body is formed of a molded plastic lacking any metallic inserts.

4. The drum protector according to claim 2, wherein said main body is u-shaped in its cross section.

5. The drum protector according to claim 2, wherein said internal wall is u-shaped.

6. The drum protector according to claim 2, wherein said aperture is a semi-circular aperture.
